(19) United States
(12) Patent Application Publication
(10) Pub. No.: US 2006/0136836 A1
(43) Pub. Date: Jun. 22, 2006

(54) User interface with scroll bar control

(76) Inventors: Scott John Clee, Winchester (GB); Robert Harris, Christchurch (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/301,941

(22) Filed: Dec. 13, 2005

(30) Foreign Application Priority Data
Dec. 18, 2004 (GB) 0427811.5

(51) Int. Cl. G06F 9/00

(52) U.S. Cl. 715/781; 715/786; 715/800

(57) ABSTRACT

A user interface is provided for displaying content supplied by a content provider in a view window. When the user interface detects user selection of zoom view mode, display settings of the view window are saved and a resized form of the document is displayed in the view window. When user selection of a location in the document is next detected, the user interface displays a portion of the document corresponding to the selected location, according to the previous display settings, such as display resolution/font size.

### BACKGROUND OF THE INVENTION

The present invention relates to the field of data processing and, in particular, the display of documents and other data in a windowing system.

A scroll bar control is used in a user interface to indicate to a user of a windowing system that more of the object being displayed is available beyond the current extent (horizontal and/or vertical) of the view in the window. A scroll bar control contains a slider, which enables the user to manipulate the view to make visible the user desired part of the presentation space. The location of the slider within the scroll bar control indicates the placement of the displayed view relative to the extent of the displayed object/document (left to right, or, top to bottom, respectively). The length of the slider compared to the length of the scroll bar usually indicates the ratio of the size of the portion of document visible to that which is not currently visible.

A cursor control device, such as a mouse or trackball device, is used to control the scroll bar. Typically, a user can manipulate the displayed view by dragging the slider to some position in the scroll bar control. Alternatively, the user scrolls down a view incrementally in units of a row/column or in larger units, such as page size or the horizontal/vertical view dimension, by clicking on the scroll bar above or below the slider. A scroll bar typically also has a scroll button at each end which allows a user to scroll up/down or left/right (by units using single mouse clicks or continuously by holding down the scroll button) through the presentation space.

In the case of a horizontal scroll bar, a slider can be moved horizontally between a left bound (conventionally, the minimum position) and a right bound (conventionally, the maximum position). Similarly, in the case of a vertical scroll bar, a slider can move vertically between a lower bound (conventionally the bottom or maximum position) and an upper bound (conventionally the top-most or minimum position).

The major use of a scroll bar is to position a view window over an object to the displayed, where the view window, sometimes termed the ‘viewport’, is smaller than the object to be displayed. Scroll bars are used to position the partial view of that object, as will now be described with reference to FIGS. 1a, 1b and 1c, in which the use of conventional scroll bars 102, 112 in a windowing application will be described. The window 100 displays a portion of a document 120, which is shown in its entirety in FIG. 1c.

The positioning of the viewport to show the desired area of the letter may involve several operations. For example, a user must position a cursor over the scroll bar slider of a first scroll bar control (e.g. the horizontal scroll bar control 102) and select the slider 104, for example by clicking a mouse button; then move the cursor horizontally to the desired horizontal position (as shown in FIG. 1b), before releasing the scroll bar slider. As the slider is moved, a different portion of the document 120 is displayed in the viewport. As shown in FIG. 1b, by moving the slider to the right, the right uppermost corner of the document is now shown in the viewport, rather than the left uppermost corner of the document.

This process may need to be repeated to scroll in a second direction; for example, by using the scroll bar slider 112 on the vertical scroll bar control 114 to re-position the viewport as required further down the document.

Sometimes this scrolling process may have to be repeated to display the required part of the document; for example, when the user does not know where the boundaries of the required area are in relation to the whole document. Using the example of FIGS. 1a, 1b and 1c, further scrolling would be required if the user were trying to display the numeral 37 in the document, as the view window would have to be moved back to the left of the document (bottom leftmost corner). In practice, this means that there can be a lot of wandering back and forth using both scroll bar controls to achieve the desired positioning.

This sequence of operations is difficult and unwieldy for people without a high degree of manual dexterity in mouse movement. This is an increasingly important criterion for usability.

The present invention aims to address these problems and enhance the usability of scroll bars and reduce the number of move/pointing device operations required in order to position the viewport in the desired location over an underlying object.

### SUMMARY OF THE INVENTION

A first aspect of the invention provides a user interface for use with an application displaying a portion of a document in a view window. When the user interface detects user selection of zoom view mode, display settings of the view window are saved and a resized form of the document is displayed in the view window. When user selection of a location in the document is next detected, the user interface displays a portion of the document corresponding to the selected location, according to the previous display settings.

The present invention thus provides a novel method of manipulating the presentation space using the slider component of a scroll bar. This new functionality reduces the number of interactions required in order to manipulate the view and is particularly useful for people with restricted hand movements and those who have difficulty in manipulating a mouse.

A second aspect of the invention provides a method of manipulating the display of a document in a view window. The method comprises detecting user selection of zoom view mode; saving display settings of the view window; displaying a resized form of the document in the view window; detecting user selection of a location in the document; and displaying in the view window a portion of the document corresponding to the selected location using the previous display settings, such as display resolution.

### BRIEF DESCRIPTION OF THE DRAWINGS

Preferred embodiments of the present invention will now be described by way of example only, with reference to the accompanying drawings in which:

FIGS. 1a, and 1b show examples of view windows with scroll bar controls;

FIG. 1c shows the document being displayed in the windows of FIGS. 1a and 1b;

FIG. 2 shows a schematic representation of a data processing system according to an embodiment of the present invention; and

FIGS. 3a, 3b and 3c show view windows that may be displayed during use of the page view mode according to an embodiment of the invention.

### DESCRIPTION OF THE PREFERRED EMBODIMENTS

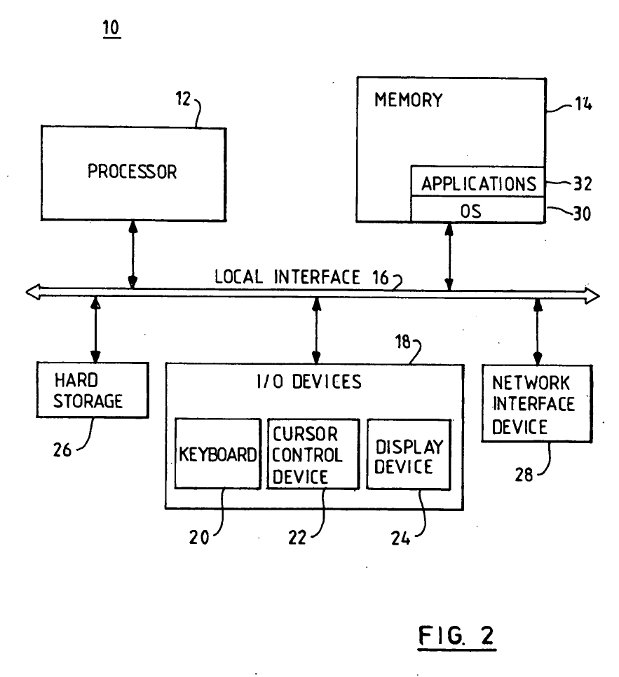

Referring to FIG. 2, there is shown a schematic and simplified representation of an illustrative implementation of a data processing system 10. As shown in FIG. 2, the data processing system comprises a processor (CPU) 12, and memory 14 coupled to a local interface 16. One or more user-input devices 18, such as a keyboard 20, cursor control device 22 and display device 24 are connected to the local interface 16. Additionally, hard storage 26 and a network interface device 28 are provided.

Illustrated within memory 14 in FIG. 2, are operating system (OS) 30 and applications 32, which are currently being run on the data processing system 10. The OS is a software (or firmware) component of the data processing system 10 that provides an environment for the execution of programs by providing specific services to the programs, including loading the programs into memory and running the programs. The OS also manages the sharing of internal memory among multiple applications and/or processes, and handles input and output control, file and data management, communication control and related services. Application programs make requests for services to the OS through an application program interface (not shown).

The data processing system 10 may comprise, for example, a personal computer (PC), laptop, server, workstation, or a portable computing device, such as a personal digital assistant (PDA), mobile telephone or the like. Furthermore, data processing system 10 may comprise additional components not illustrated in FIG. 2, and, in other embodiments, may not include all of the components illustrated in FIG. 2.

Referring again to FIG. 2, the various components of data processing system 10 will be described. The processor 12 may be a hardware device for executing software located in memory 14, and may be any custom made or commercially available processor, a central processing unit (CPU), a semiconductor based microprocessor, a macroprocessor, or generally any device for executing software instructions.

Memory 14 may include any one or combination of volatile memory elements (e.g., random access memory (RAM, such as DRAM, SRAM, SDRAM, etc.)) and non-volatile memory elements (e.g., ROM, hard drive, tape, CDROM, DVDROM etc.). Memory 14 may incorporate electronic, magnetic, optical, and/or other types of storage media. Memory 14 may also have a distributed architecture, with various components being situated remote from one another, but being accessible by the processor 12.

Local interface 16 may be, for example, one or more buses or other wired or wireless connections and may comprise additional elements that are omitted for simplicity, such as controllers, buffers (caches), drivers, repeaters, and receivers. Further, local interface 16 may include address, control, and/or data connections to enable appropriate communications among components of the data processing system 10.

Input/output (I/O) devices 18 may comprise any device configured to communicate with local interface 16. In FIG. 2, a keyboard 20, cursor control device 22 and display device 24 are shown. Additional input/output devices such as optical drives, floppy disk drives, cameras, I/O ports, printers, speakers, microphones, scanners, etc. could also be provided.

Cursor control device 22 may comprise any input device configured to cooperate with an application 32 and/or OS 30, and manipulate one or more cursor(s) displayed on the display device 24. For example, cursor control device 22 may comprise, but is not limited to: a mouse, a trackball, a set of navigation keys (e.g., arrow keys), a touchpad, a joystick or a touch sensitive screen.

Network interface device 28 may be any device configured to interface between the data processing system 10 and a computer or telecommunications network, such as a Local Area Network (LAN), a private computer network, a public or private packet-switched or other data network including the Internet, a circuit switched network, or a wireless network.

A computer program for implementing various functions or for conveying information may be supplied on carrier media, such as one or more DVD/CD-ROMs 46, floppy disks 48, and/or USB storage devices, and then stored on a hard disk, for example. The data processing system shown in FIG. 2 may be connected to a network such as the Internet, or a local or wide area dedicated or private network, for example, via the network interface device 28.

A program implementable by a data processing system may also be supplied on a telecommunications medium; for example, over a telecommunications network and/or the Internet, and embodied as an electronic signal. For a data processing system operating as a wireless terminal over a radio telephone network, the telecommunications medium may be a radio frequency carrier wave carrying suitable encoded signals representing the computer program and data. Optionally, the carrier wave may be an optical carrier wave for an optical fibre link, or any other suitable carrier medium for a telecommunications system.

The preferred embodiment of the invention provides a new operation mode of sliders on scroll bars, which is typically a new function activated by a double mouse click, or particular user input, associated with the slider. When a user selects this mode, the size of the currently displayed page is temporarily reduced so that it will fit in its entirety in the viewport. A next user input selecting a position on the displayed page results in the restoration of the previous image display settings (such as the font size), with the view displayed in the viewport corresponding to the position selected by the user. This is called hereafter “page view” or “zoom view” mode of operation. The view corresponding to the selected position is preferably centred, within the viewport, on the selected position.

In terms of the steps taken by the user interface/window controller, when user selection of page view mode is detected, it saves the current display context, sends the appropriate resizing message to the application owning the viewport window (i.e. the content provider), interprets a subsequent click in terms of the x/y positioning within the current window, restores the previous display context and generates the relevant movement messages to the application window.

This differs to known zoom modes of operation in which a user can select the operations of zooming in or out of a document, typically by clicking on a zoom icon. In these modes of operation, successive clicks of the mouse within the document lead to successive zooming in or out according to the mode selected. The new zoom view mode of the present invention allows the user to zoom, and then to select a new location in the document, and to zoom back to the original resolution in one step.

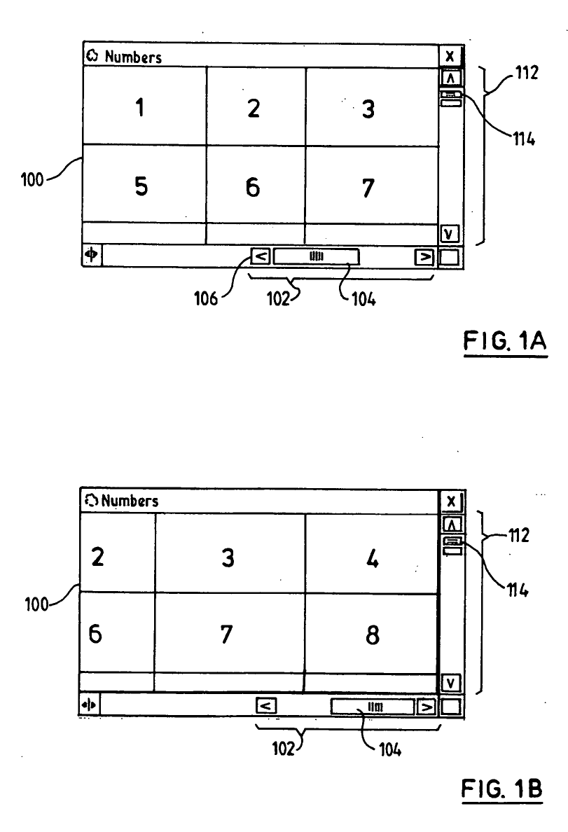

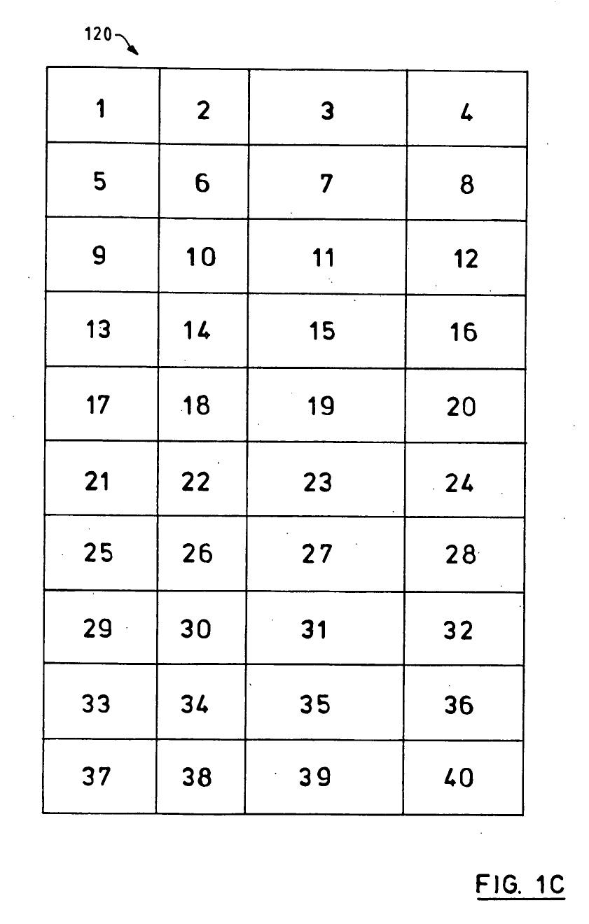

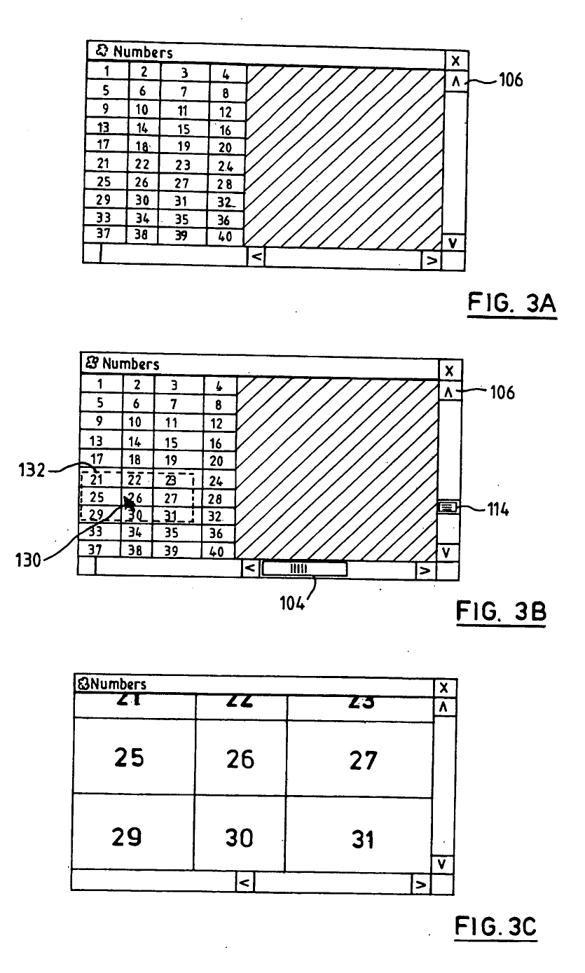

Let us go back to the example of FIGS. 1a, and 1c, and describe the user interface of the preferred embodiment. When a user selects page view mode, the user interface (for example, by double clicking on the scroll bar slider) the user interface saves the font size of the display, and then sends a message to the ‘Numbers’ application that controls the window, telling it to resize the current page displayed 120 such that the full page is displayed in the window 100. The effect of the page view mode changes the viewport to cover the whole of the page in lower resolution to yield a view window as shown in FIG. 3a. Observe that the scroll bar controls do not have a slider during this page view mode because the whole of the page fits in the window.

The user then selects the desired display area by positioning the cursor 130 (or other pointing device) over the location of interest. As shown in FIG. 3b, a ghost window 132 may be displayed in the vicinity of the cursor to indicate to a user the extent of the viewport window that would be displayed if the user were to select the current cursor location. The user can then input selection of a location on the full document, for example by a subsequent mouse click. The user interface then interprets the new location of the viewport with respect to the document, restores the previous display context (e.g. font), and generates the relevant movement messages to the application window. The user interface also moves the relevant scroll bar sliders to the appropriate position.

The use of page view mode functionality on scroll bar sliders permits a reduction of mouse/pointing device movement to position a cursor at the required location in a presentation space. In the preferred embodiment, this enhanced usability is provided by introducing an additional double click mode to slider operation.

The activation of page view mode is not restricted to being triggered via a double click on a scroll bar slider. A double or single mouse click on a part of a page that does not normally respond to an action (so the pointer device/mouse is not positioned over things like links or icons) could similarly initiate this new mode. Alternatively, a separate icon could be used to represent the page view mode, which may then be selected by selection of the icon, however, it is preferred that a scroll bar slider be used. Similarly, the use of a double click to initiate page view mode functions can be generalized to any button with any number of clicks in any pointing device.

In the case of a mobile device, a user may enter a user input associated with a scroll bar slider with the touch of a stylus on a touch sensitive screen, for example, with a long prod indicating activation of the page view mode.

The foregoing discusses the use of the page view function on the basis of viewport manipulation for a given page, such as a webpage. Naturally, this extends into an environment whereby a plurality of pages is potentially viewable. The page view function, as described in the main embodiment, works on a given page. However, an extension is to provide functionality for multiple pages (or, at least, as many as can be usefully seen in the existing viewport).

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system, or may be embodied as object code, for example.

Suitably, the computer program is stored on a carrier medium in machine or device readable form; for example, in solid-state memory, magnetic memory such as disc or tape, optically or magneto-optically readable memory such as compact disk (CD) or Digital Versatile Disk (DVD) etc, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the preceding example embodiments, the invention is not limited thereto and that there are many possible variations and modifications that fall within the scope of the invention.

The scope of the present disclosure includes any novel feature or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims, and features from respective independent claims may be combined in any appropriate manner and not merely in the specific combinations enumerated in the claims.

For the avoidance of doubt, the term “comprising”, as used herein throughout the description and claims is not to be construed as meaning “consisting only of”.

1. A method for displaying a document in a view window, the method comprising:
displaying a first portion of a document in a view window;
detecting user selection of a zoom view mode;
saving display settings of the view window;
resizing and displaying the document in the view window;
detecting user selection of a location in the document; and
using the saved display settings, displaying a second portion of the document corresponding to the selected location.

2. A method according to claim 1, further comprising:
displaying a scroll bar control, the scroll bar control having a slider to enable scrolling of the document displayed in the view window;
wherein the step of detecting user selection of zoom view mode comprises detecting a selection of the slider.

3. A method according to claim 1, further comprising:
displaying a scroll bar control, the scroll bar control having a slider to enable scrolling of the document displayed in the view window; and
repositoning the slider corresponding to the selection of the location in the document.

4. A method according to claim 2, further comprising repositoning the slider corresponding to the selection of the location in the document.

5. A method according to claims 1, wherein the step of resizing and displaying the document in the view window comprises changing the resolution of the displayed document so as to display the whole of a current page of the document in the view window.

6. A computer-usable medium embodying computer program code, the computer program code comprising computer executable instructions configured to:
display a first portion of a document in a view window;
detect user selection of a zoom view mode;
save display settings of the view window;
resize and display the document in the view window;
detect user selection of a location in the document; and
using the saved display settings, display a second portion of the document corresponding to the selected location.

7. The computer-usable medium of claim 6, wherein the embodied computer program code further comprises computer executable instructions configured to:
display a scroll bar control, the scroll bar control comprising a slider to enable scrolling of the document displayed in the view window;
wherein the computer executable instructions configured to detect user selection of zoom view mode further comprises instructions to detect a selection of the slider.

8. The computer-usable medium of claim 6, wherein the embodied computer program code further comprises computer executable instructions configured to:
display a scroll bar control, the scroll bar control comprising a slider to enable scrolling of the document displayed in the view window; and
repositon the slider corresponding to the selection of the location in the document.

9. The computer-usable medium of claim 7, wherein the embodied computer program code further comprises computer executable instructions configured to repositon the slider corresponding to the selection of the location in the document.

10. The computer-usable medium of claim 6, wherein the computer executable instructions configured to resize and display the document in the view window further comprises instructions configured to change the resolution of the displayed document so as to display the whole of a current page of the document in the view window.

11. A system comprising:
a processor;
a data bus coupled to the processor;
a memory coupled to the data bus; and
a computer-usable medium embodying computer program code, the computer program code comprising instructions executable by the processor and configured to:
display a first portion of a document in a view window;
detect user selection of a zoom view mode;
save display settings of the view window;
resize and display the document in the view window;
detect user selection of a location in the document; and
using the saved display settings, display a second portion of the document corresponding to the selected location.

12. The system of claim 11, wherein the instructions are further configured to:
display a scroll bar control, the scroll bar control comprising a slider to enable scrolling of the document displayed in the view window;
wherein the computer executable instructions configured to detect user selection of zoom view mode further comprises instructions to detect selection of the slider.

13. The system of claim 11, wherein the instructions are further configured to:
display a scroll bar control, the scroll bar control comprising a slider to enable scrolling of the document displayed in the view window; and
repositon the slider corresponding to the selection of the location in the document.

14. The system of claim 12, wherein the instructions are further configured to reposition the slider corresponding to the selection of the location in the document.

15. The sytem of claim 11, wherein the computer executable instructions configured to resize and display the document in the view window further comprises instructions configured to change the resolution of the displayed document so as to display the whole of a current page of the document in the view window.
